(19) United States
(12) Patent Application Publication
(10) Pub. No.: US 2014/0268005 A1
(43) Pub. Date: Sep. 18, 2014

(54) COLLAPSIBLE EYEGLASSES

(71) Applicant: Michael Richard Pluta, Huntington Beach, CA (US)

(72) Inventor: Michael Richard Pluta, Huntington Beach, CA (US)

(21) Appl. No.: 13/951,363

(22) Filed: Jul. 25, 2013

Related U.S. Application Data
(60) Provisional application No. 61/794,332, filed on Mar. 15, 2013.

(51) Int. Cl. G02C 5/00

(52) U.S. Cl. CPC G02C 5/006
USPC 351/63

(57) ABSTRACT

Collapsible eyeglasses allow the user to pivot or rotate the lenses relative to each other to reduce the overall size of the eyeglasses for storage in a collapsed configuration. The eyeglass frames with lenses could rotate relative to each other about a pivot point positioned on or about the bridge of the eyeglasses. The eyeglass frames with lenses could hinge relative to each other about a point on or about the bridge of the eyeglasses. The eyeglass frames with lenses could be separated from each other. The invention provides eyeglasses that are more easily stored, are more convenient to carry, and more convenient to use.

This application claims the benefit of U.S. Provisional Patent Application No. 61/794,332, filed on Mar. 15, 2013, which is hereby incorporated by reference for all purposes as if fully set forth herein.

### BACKGROUND OF THE INVENTION

The present invention relates to eyewear. More particularly, the present invention relates to collapsible eyeglasses.

Storing eye glasses can be a problem. Most eyeglasses, especially the wrap around style, are bulky and expensive. The conventional hard cases need to be quite large to encapsulate the eyeglasses including the stems. The bulky cases are often not used or left behind as people find them too much trouble to carry along. As a result, eyeglasses are often set aside without any protective covering, exposing them to potential scratches, crushing, and ruin.

The consumer needs a simple, functional and fun product to protect their investment in eyeglasses. Accordingly, there exists a need for eyeglasses that take up less volume, particularly when stored, and offer protection to the frames, lenses, and stems. As explained below, the collapsible eyeglasses of the present invention satisfy this need.

### SUMMARY OF THE INVENTION

One solution to the problem of bulky eyeglasses involves a design for pivoting eyeglasses. These eyeglasses allow the user to pivot or rotate the lenses relative to each other. This capability significantly reduces the overall size or profile of the eyeglasses, when the eyeglasses are in a collapsed configuration. Because the overall size or profile of the eyeglasses is significantly reduced, smaller eyeglass covers or cases may be employed to protect the eyeglasses. In any event, the eyeglasses are easier to store, and easier to carry than conventional eyeglasses. As a result, consumers will be more inclined to use their eyeglasses and find it easier to protect their investment to extent their useful life.

The collapsible eyeglasses of the present invention will be described through a number of exemplary embodiments. For example, in one exemplary embodiment, the eyeglass frame with lenses rotate relative to each other about a pivot point positioned on or about the bridge of the eyeglasses. In another exemplary embodiment, each lens rotates rearward about its own pivot point on or adjacent to the bridge of the eyeglasses, such that the collapsed configuration takes on a clam shell appearance. In yet another exemplary embodiment, the lenses first twist and then collapse relative to each other, such that the collapsed configuration takes on a stacked arrangement. In still another exemplary embodiment, the lenses actually detach from one another, such that the user can then stack or store the two detached portions in a more compact configuration. By incorporating telescoping or detachable stems, the eyeglasses, when in the collapsed configuration, take up one-quarter to one-half the original volume. Accordingly, the present invention is directed to collapsible eyeglasses that substantially obviate one or more of the problems due to limitations and disadvantages of the related art.

An advantage of the present invention is to provide eyeglasses that are more easily stored.

Another advantage of the present invention is to provide eyeglasses that are more convenient to carry.

Another advantage of the present invention is provide a user eyeglass that the user would be more inclined to use because the eyeglasses are more convenient.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, collapsible eyeglasses, comprise: two stems each rotationally attached to a first and a second frame, respectively; the first and the second frames each incorporating a lens; a pivot mechanism rotationally attaching the first frame to the second frame such that the first and the second frames are capable of rotating relative to each other between a deployed configuration and a collapsed configuration, wherein the first and the second frames are positioned side-by-side in the deployed configuration and in a substantially overlapping position in the collapsed configuration.

In another aspect of the present invention, collapsible eyeglasses, comprise: two stems each rotationally attached to a first and a second frame, respectively; the first and the second frames each incorporating a lens; a first hinge mechanism to rotationally attach the first frame to a bridge; and a second hinge mechanism to rotationally attach the second frame to the bridge, wherein the first and the second frames are capable of rotating towards each other, between a deployed configuration and a collapsed configuration, and wherein the first and the second frames are positioned side-by-side in the deployed configuration and in a substantially overlapping position in the collapsed configuration.

In another aspect of the present invention, collapsible eyeglasses, comprise: two stems each rotationally attached to a first and a second frame, respectively; the first and the second frames each incorporating a lens; a connection mechanism to attach the first frame and the second frame to each other such that the first and the second frame are capable of being moved, relative to each other, from a deployed configuration and stacked into a collapsed configuration, wherein the first and the second frame are positioned side-by-side in the deployed configuration and in a substantially overlapping position in the collapsed configuration.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1A-1D illustrate collapsible eyeglasses according to a first exemplary embodiment of the present invention;

FIGS. 2A-2D illustrate collapsible eyeglasses according to another aspect of the first exemplary embodiment;

FIGS. 3A-3D illustrate collapsible eyeglasses according to a second exemplary embodiment of the present invention;

FIGS. 4A-4D illustrate collapsible eyeglasses according to another aspect of the second exemplary embodiment;

FIGS. 5A-5D illustrate collapsible eyeglasses according to a third exemplary embodiment of the present invention; and

FIGS. 6A-6C illustrate collapsible eyeglasses according to another aspect of the third exemplary embodiment.

### DETAILED DESCRIPTION OF THE ILLUSTRATED EMBODIMENTS

It is to be understood that both the foregoing general description and the following detailed description are exemplary. The descriptions are not intended to limit the scope of the invention. The scope of the present invention is governed by the scope of the claims. Reference will now be made in detail to an embodiment of the present invention, examples of which are illustrated in the accompanying drawings.

FIGS. 1A-1D illustrate collapsible eyeglasses 100 according to a first exemplary embodiment. FIG. 1A shows a top view of collapsible eyeglasses 100 including a pivot mechanism 120. The collapsible eyeglasses 100 include frame portions 105a, 105b which hold in place lenses 115, and two stems 110, which aid in holding the eyeglasses in place on the users head, as are customary in the art. The stems 110 and frames 105a, 105b can be made of plastic, metal, wood, or any other suitable material. The lenses 115 can be made of glass, plastic, crystal, or any other suitable material. Further, the lenses can be clear, tinted, polarized, and include any suitable coating used to enhance durability or optics. Typically, the stems 110 are rotationally attached to the frame 105 with a hinge. The stems 110 are nominally oriented orthogonal to frames 105a and 105b during use and parallel to the frames 105a and 105b when the eyeglasses 100 are in the collapsed configuration. FIG. 1B shows a top view of collapsible eyeglasses 100 in a collapsed configuration. FIG. 1C shows a front view of collapsible eyeglasses 100 including lenses 115 with the stems omitted for clarity. FIG. 1D illustrates a front view of collapsible eyeglasses 100 in a collapsed configuration.

The frames 105a and 105b each comprise a corresponding bridge portion. As shown, the collapsible eyeglasses include a bridge 118 which comprises the corresponding bridge portions of the frames 105a, 105b.

The collapsible eyeglasses 100 employ a pivot mechanism 120, offset from the center of the bridge 118, where frames 105a and 105b are rotationally attached and overlap each other. The pivot mechanism 120 can be fashioned with a pin, a post, a rivet, ball and socket, or any other fastening method such that the pivot 120 allows frames 105a, 105b to be joined together and rotate relative to each other. In this exemplary embodiment, the pivot mechanism 120 is slightly offset from center and frames 105a and 105b are offset front to back. This allows frame 105a, with the corresponding lens 115, to slide over frame 105b, with the corresponding lens 115 when frames 105a and 105b are rotated relative to each other about the pivot mechanism 120 in order to place eyeglasses 100 in the collapsed configuration.

In FIGS. 1A, 1B, and 1D, stems 110 are illustrated as being attached to frames 105a and 105b by a hinge (not shown), so that the stems 110 may be rotated about the hinge when placing eyeglasses 100 in the collapsed configuration. However, the stems 110 may also be hinged somewhere along the length of the stems or otherwise configured so that the length of the stems can be reduced. If the length of the stems 110 can be reduced, it may be possible to even further reduce the overall size or profile of eyeglasses 100 in the collapsed configuration.

FIGS. 2A-2D illustrate an alternative for the first exemplary embodiment. As illustrated, collapsible eyeglasses 200 have nose pads 225 protruding from the bridge 130 of eyeglasses 200, as is common in many styles and brands of eyeglasses. FIG. 2A specifically illustrates a top view of the collapsible eyeglasses 200 shown with stems 110, nose pads 225, and frames 205a, 205b. FIG. 2B illustrates a front view of collapsible eyeglasses 200 with the stems 110 omitted for clarity. FIG. 2C illustrates a front view of collapsible eyeglasses 200 in a collapsed configuration. FIG. 2D shows a top view of collapsible eyeglasses 200 in a collapsed configuration.

In accordance with this alternative to the first exemplary embodiment of the invention, the nose pads 225 remain intact and connected to one of the frames 205a or 205b. The other frame can then rotate unobstructed in front of the frame that is connected to the nose pads 225. This alternative allows the collapsible eyeglasses 200 to be placed in the collapsed configuration without interference from the nose pads 225.

FIGS. 3A-3D illustrate collapsible eyeglasses 300 according to a second exemplary embodiment. As illustrated in FIG. 3A, collapsible eyeglasses 300 include frames 305a and 305b, stems 310, lenses 315, nose pad 325, and bridge 330. FIG. 3B shows a side view of collapsible eyeglasses 300 in a collapsed configuration. FIG. 3C shows a top view of collapsible eyeglasses 300 in a collapsed configuration. FIG. 3D depicts a front view of collapsible eyeglasses 300 in a collapsed configuration with the stems 310 omitted for clarity.

The exemplary embodiment illustrated in FIGS. 3A-3D utilizes two hinge mechanisms 360 to allow the eyeglasses 300 to fold. The hinge mechanisms 360 may be fashioned with a pin, a post, a rivet, a ball and socket or any other like mechanism. The hinge mechanisms 360 allow the bridge 330 and nose pads 325 to remain as a single unit while each of the frames 305a and 305b are capable of being rotated towards the other in the direction of the arrows shown in FIG. 3A. This exemplary embodiment is also capable of accommodating eyeglasses 300 with protruding nose pads.

In accordance with the second exemplary embodiment, as in the first exemplary embodiment, the user can fold the stems 310 from a deployed configuration, as illustrated in FIG. 3A, towards the rear of the frames 305a, 305b, as is customary in the art. The user can then also fold the frames 305a, 305b in towards each other as described above, and, as illustrated in FIGS. 3B and 3D, which depict eyeglasses 300 in the collapsed configuration.

Further in accordance with this second exemplary embodiment, collapsible eyeglasses 300 may include a release mechanism 340. The release mechanism 340 locks the frames 305a and 305b in the deployed configuration, as shown in FIG. 3A. As illustrated, release mechanism 340 may be incorporated in the bridge 330. The release mechanism 340 may involve a button, latch, knob, switch, or other like feature capable of locking frames 305a and 305b and may be located on the top of the bridge 330 as shown in FIG. 3C. When the user actuates the release mechanism 340, frames 305a and 305b are unlocked and are free to rotate as facilitated by the respective hinge mechanisms 360. The user may further fold the stems 310 from a deployed configuration where the stems 310 all generally orthogonal to frames 305a and 305b, as illustrated in FIG. 3A, to a collapsed configuration, where the stems 310 are generally parallel to frames 305a and 305b, as illustrated in FIGS. 3B and 3D. As shown in FIGS. 3B-3D, the profile of the eyeglasses 300 in the collapsed configuration is significantly reduced making the eyeglasses 300 smaller and easier to store and carry.

Even further in accordance with this second exemplary embodiment, collapsible eyeglasses 300 may include a deployment mechanism 350. When the user actuates deployment mechanism 350, it causes frames 305a and 305b to move from the collapsed configuration to the deployed configuration. In FIGS. 3A and 3D, deployment mechanism 350 is incorporated in the bridge 330. The deployment mechanism 350 may include a spring (not shown) or other like device to aid the deployment of frames sections 305a and 305b. Like the release mechanism 340, the deployment mechanism 350 may involve a button, latch, knob, switch, or other like feature located on the top of the bridge 330. However, this location is exemplary.

FIGS. 4A-4D illustrate an alternative to the second exemplary embodiment described above. Features shown in FIGS. 4A-4D that are similar to those depicted in FIGS. 3A-3D, and described above, are omitted for brevity. FIG. 4A shows a perspective view of collapsible eyeglasses 400 including frames 405a and 405b, stems 310, lenses 315, and bridge 430. FIG. 4B shows a side view of collapsible eyeglasses 400 in a collapsed configuration. FIG. 4C shows a top view of collapsible eyeglasses 400 in a collapsed configuration including nose pads 425. FIG. 4D depicts a front view of collapsible eyeglasses 400 in a collapsed configuration.

The alternative embodiment illustrated in FIGS. 4A-4D also employs two hinge mechanisms 360. As shown in FIGS. 4B-4D, the two hinge mechanisms 360 allow frames 305a and 305b to rotate toward each other and with respect to the bridge 330, as indicated by the arrows. Unlike the embodiment illustrated in FIGS. 3A-3D, nose pads 425 are attached to the frames 405a and 405b. Thus, the nose pads 425 rotate with the frames 405a and 405b when the user places the eyeglasses 400 in a collapsed configuration. This alternative to the second exemplary embodiment accommodates eyeglasses that employ nose pads 425 which are distinct structures separate and apart from the bridge 430.

This alternative embodiment also may incorporate the release mechanism 340 and/or deployment mechanism 350 described above with respect to FIGS. 3A-3D. Again, the description of these features is omitted for brevity.

FIGS. 5A-5D illustrate eyeglasses 500 according to a third exemplary embodiment of the present invention. FIG. 5A shows a front view of eyeglasses 500 including a twist and stack mechanism 515. The eyeglasses 500 include two frames 505a and 505b which incorporate lenses 115. The twist and stack mechanism 515 allows the user to rotate frames 505a and 505b relative to each other and then stack the frames 505a and 505b, one over the other in a compact, collapsed configuration, as shown. FIG. 5B illustrates the frames 505a and 505b twisted with respect to each other. FIG. 5C illustrates the frames 505a and 505b twisted and stacked one on the other. FIG. 5D is an expanded view illustrating an exemplary twist and stack mechanism 515.

More specifically, as shown in FIG. 5B, the twist and stack mechanism 515 allows the user to first twist the frames 505a and 505b with respect to each other such that one frame appears inverted relative to the other. For example, FIG. 5B shows frame 505b inverted relative to frame 505a. Once twisted, the frames 505a and 505b can be stacked, one on the other, as shown in FIG. 5C.

More specifically, FIG. 5D illustrates an exemplary configuration for the twist and stack mechanism 515 in the form of a ball and socket. As shown, one frame, e.g. 505b, comprises a ball portion 516 including a ball 516a on a post 516b, whereas the other frame, e.g. 505a, comprises a socket 517 including a spherical opening 517a and a slot 517b. In this exemplary embodiment, the ball 516 is received by the spherical opening 517a.

Further, with regard to this embodiment, the user may rotate frames 505a and 505b relative to each other so that the socket 517 rotates around the ball portion 516. The user continues to rotate the frames until one of the frames has been rotated substantially 180 degrees relative to the other frame, as illustrated in FIG. 5B. Making sure the stems are collapsed, the user can then stack the frames 505a and 505b onto each other so they are in the collapsed configuration, as illustrated in FIG. 5C.

In accordance with an alternative to this exemplary embodiment, the user may physically separate the two frames 505a and 505b by removing the ball portion 516 from within the socket 517. The user may want to do this when storing the eyeglasses 500. The user may then reconnect the frames 505a and 505b by fitting the ball portion 516 back into the socket 517.

FIGS. 6A-6C illustrate yet another exemplary embodiment of the present invention. In this exemplary embodiment, the eyeglasses 600 include a connecting mechanism. FIG. 6A shows a front view of the eyeglasses 600 in a deployed configuration. FIG. 6B shows an expanded front section view of an exemplary connection mechanism with the frames 605a and 605b separated. FIG. 6C shows an expanded rear section view of the same exemplary connection mechanism, where frames 605a and 605b are separated.

More specifically, FIG. 6A shows frames 605a and 605b connected together at bridge portion 630. As illustrated in FIG. 6B, one frame, for example 605b, includes a protrusion 615 from bridge portion 630 to form a male component of the connection mechanism. The other frame, for example, 605a, includes a groove 620 in the bridge portion 630 to form a female component of the connection mechanism. The connection mechanism may take the form of a latch, snap fit, twist lock, magnet, or other suitable alternative.

As illustrated in FIGS. 6B and 6C, the protrusion 615 fits into the groove 620 to fasten the frames 605a and 605b together. As shown, groove 620 is keyed to include an offset 625 to one side of the groove 620 such that a prolusion 615 with a catch 626 to one side will fit into the groove 620 with a unique orientation. The catch 626 is a smaller protrusion extending from one side of protrusion 615. As illustrated in FIG. 6C, the catch 626 can fit into a hole 627 in a portion of the bridge 630 formed in frame section 605a to more securely fasten the frame sections 605a, 605b together for use.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. Collapsible eyeglasses, comprising:
two stems each rotationally attached to a first and a second frame, respectively;
the first and the second frames each incorporating a lens;
a pivot mechanism rotationally attaching the first frame to the second frame such that the first and the second frames are capable of rotating relative to each other between a deployed configuration and a collapsed configuration,
wherein the first and the second frames are positioned side-by-side in the deployed configuration and in a substantially overlapping position in the collapsed configuration.

2. The collapsible eyeglasses of claim 1, wherein the pivot mechanism includes one of a pin, a post, a rivet, and a ball and socket.

3. The collapsible eyeglasses of claim 1, further comprising a bridge, wherein the bridge comprises:
a first bridge component of the first frame; and
a second bridge component of the second frame,
wherein the pivot mechanism is offset from a center of the bridge and the first and the second bridge components are offset, front to back, from each other.

4. The collapsible eyeglasses of claim 1, further comprising:
a nose pad protruding from the bridge, wherein the nose pad remains intact and connected to the bridge such that the first and the second frames can rotate unobstructed relative to each other.

5. Collapsible eyeglasses, comprising:
two stems each rotationally attached to a first and a second frame, respectively;
the first and the second frames each incorporating a lens;
a first hinge mechanism to rotationally attach the first frame to a bridge; and
a second hinge mechanism to rotationally attach the second frame to the bridge,
wherein the first and the second frames are capable of rotating towards each other, between a deployed configuration and a collapsed configuration, and
wherein the first and the second frames are positioned side-by-side in the deployed configuration and in a substantially overlapping position in the collapsed configuration.

6. The collapsible eyeglasses of claim 5, further comprising:
a release mechanism capable of locking the first and the second frames in the deployed configuration and unlocking the first and the second frames to allow the first and the second frames to rotate towards the other frame in the collapsed configuration.

7. The collapsible eyeglasses of claim 6, wherein the release mechanism involves one of a button, a latch, a knob, and a switch.

8. The collapsible eyeglasses of claim 6, wherein the release mechanism is incorporated in the bridge.

9. The collapsible eyeglasses of claim 5, further comprising:
a deployment mechanism that causes the first and the second frames to move from a collapsed configuration to a deployed configuration.

10. The collapsible eyeglasses of claim 9, wherein the deployment mechanism includes a spring.

11. The collapsible eyeglasses of claim 9, wherein the deployment mechanism involves one of a button, a latch, a knob, and a switch.

12. The collapsible eyeglasses of claim 9, wherein the deployment mechanism is incorporated into the bridge.

13. The collapsible eyeglasses of claim 5, further comprising:
a nose pad attached to the bridge.

14. The collapsible eyeglasses of claim 5, further comprising:
a first nose pad attached to the first frame; and
a second nose pad attached to the second frame,
wherein the first and the second nose pads each rotate with the respective frame.

15. Collapsible eyeglasses, comprising:
two stems each rotationally attached to a first and a second frame, respectively;
the first and the second frames each incorporating a lens;
a connection mechanism to attach the first frame and the second frame to each other such that the first and the second frame are capable of being moved, relative to each other, from a deployed configuration and stacked into a collapsed configuration,
wherein the first and the second frame are positioned side-by-side in the deployed configuration and in a substantially overlapping position in the collapsed configuration.

16. The collapsible eyeglasses of claim 15, wherein the connection mechanism is a ball and a socket.

17. The collapsible eyeglasses of claim 16, wherein the ball is attached to one of the first and the second frames and the socket is formed in the other of the first and the second frames.

18. The collapsible eyeglasses of claim 17, wherein the first and the second frames are capable of being physically separated from each other and reconnected.

19. The collapsible eyeglasses of claim 15, wherein the connection mechanism is one of a latch, a snap fit, a twist lock, and a magnet.

20. The collapsible eyeglasses of claim 15, wherein the connection mechanism is a protrusion on one of the first and the second frames, the protrusion fitting into a groove formed in other of the first and the second frames.
